(19) United States
(12) Patent Application Publication
(10) Pub. No.: US 2013/0178769 A1
(43) Pub. Date: Jul. 11, 2013

(54) SEXUAL STIMULATION DEVICE WITH INTERCHANGEABLE SHEATHS

(71) Applicant: Shelley Jane Schmidt, Granada Hills, CA (US)

(72) Inventor: Shelley Jane Schmidt, Granada Hills, CA (US)

(21) Appl. No.: 13/708,057

(22) Filed: Dec. 7, 2012

Related U.S. Application Data
(60) Provisional application No. 61/568,797, filed on Dec. 9, 2011.

(51) Int. Cl. A61H 19/00; A61H 1/00

(52) U.S. Cl. CPC A61H 19/44; A61H 1/00
USPC 601/46

(57) ABSTRACT

Described is a sexual stimulation device that allows a user to selectively change the exterior texture or pleasure pattern. The device includes a handle component with a first vibrating member extending from the handle component. The first vibrating member is operable for providing a vibration sensation. A first interchangeable sheath is provided with a first exterior texture. The first interchangeable sheath is adapted to detachably attach with the first vibrating member. Additionally, a second interchangeable sheath with a second exterior texture is provided. As was the case above, the second interchangeable sheath is adapted to detachably attach with the first vibrating member. Importantly, the second exterior texture is distinct from the first exterior texture.

### CROSS-REFERENCE TO RELATED APPLICATIONS

This is a Non-Provisional Utility Patent Application of U.S. Provisional Application No. 61/568,797, filed on Dec. 9, 2011, entitled, “2 in 1 thermal dildo.”

### BACKGROUND OF THE INVENTION

(1) Field of Invention

The present invention relates to a sexual stimulation device and, more particularly, to a vibrator with interchangeable covers having different textures and pleasure patterns.

(2) Description of Related Art

Vibrators have long been used as sexual stimulation devices. Traditional vibrator devices have various vibration settings to provide varying levels of stimulation to the user. While operable to vary the vibration settings, existing vibrators do not allow a user to selectively change the exterior texture of the vibrator.

Thus, a continuing need exists for a vibration device that allows a user to selectively change the exterior of the device to provide for different textures and pleasure patterns.

### SUMMARY OF INVENTION

The present invention is directed to a vibrator with interchangeable covers having different textures and pleasure patterns. More specifically, the invention is a sexual stimulation device that allows a user to selectively change the exterior texture or pleasure pattern. The device includes a handle component with a first vibrating member extending from the handle component. The first vibrating member is operable for providing a vibration sensation. A first interchangeable sheath is provided with a first exterior texture. The first interchangeable sheath is adapted to detachably attach with the first vibrating member. Additionally, a second interchangeable sheath with a second exterior texture is provided. As was the case above, the second interchangeable sheath is adapted to detachably attach with the first vibrating member. Importantly, the second exterior texture is distinct from the first exterior texture.

In another aspect, the invention includes a second vibrating member extending from the handle component, the second vibrating member being operable for providing a vibration sensation. Additionally, both a third interchangeable sheath with a third exterior texture and a fourth interchangeable sheath with a fourth texture are included. Both the third and fourth interchangeable sheaths are adapted to detachably attach with the second vibrating member. In this aspect, the fourth exterior texture is distinct from the third exterior texture.

In another aspect, each vibrating member includes a base connection member and each interchangeable sheath includes a sheath connection member that is formed to matingly engage with the corresponding base connection member.

In yet another aspect, each base connection member is a channel that is formed around a circumference of the vibrating member and each sheath connection member is a ring that runs around an interior circumference of the interchangeable sheath.

Finally, as can be appreciated by one in the art, the present invention also comprises a method for forming and using the invention described herein.

### BRIEF DESCRIPTION OF THE DRAWINGS

The objects, features and advantages of the present invention will be apparent from the following detailed descriptions of the various aspects of the invention in conjunction with reference to the following drawings, where:

FIG. 1 is a side-view illustration of a sexual stimulation device according to the present invention, depicting a vibrating component with interchangeable sheaths attached thereto;

FIG. 2A is a side-view illustration of a vibrating component, depicting the vibrating component without interchangeable sheaths;

FIG. 2B is a cross-sectional side-view illustration of a first interchangeable sheath for attaching with the vibrating component;

FIG. 2C is a cross-sectional side-view illustration of a second interchangeable sheath for attaching with the vibrating component;

FIG. 3 is a side-view illustration of a sexual stimulation device according to the present invention, depicting a vibrating component with interchangeable sheaths of an alternative texture from those as depicted in FIGS. 1 through 2C;

FIG. 4 a side-view illustration of a sexual stimulation device according to the present invention, depicting a vibrating component with interchangeable sheaths having another example of an alternative texture; and

FIG. 5 is an interior-view illustration of the vibrating component, depicting various components for providing the relative vibration sensations.

### DETAILED DESCRIPTION

The present invention relates to a sexual stimulation device and, more particularly, to a vibrator with interchangeable covers having different textures and pleasure patterns. The following description is presented to enable one of ordinary skill in the art to make and use the invention and to incorporate it in the context of particular applications. Various modifications, as well as a variety of uses in different applications will be readily apparent to those skilled in the art, and the general principles defined herein may be applied to a wide range of embodiments. Thus, the present invention is not intended to be limited to the embodiments presented, but is to be accorded the widest scope consistent with the principles and novel features disclosed herein.

In the following detailed description, numerous specific details are set forth in order to provide a more thorough understanding of the present invention. However, it will be apparent to one skilled in the art that the present invention may be practiced without necessarily being limited to these specific details. In other instances, well-known structures and devices are shown in block diagram form, rather than in detail, in order to avoid obscuring the present invention.

The reader's attention is directed to all papers and documents which are filed concurrently with this specification and which are open to public inspection with this specification, and the contents of all such papers and documents are incorporated herein by reference. All the features disclosed in this specification, (including any accompanying claims, abstract, and drawings) may be replaced by alternative features serving the same, equivalent or similar purpose, unless expressly stated otherwise. Thus, unless expressly stated otherwise, each feature disclosed is only one example of a generic series of equivalent or similar features.

Furthermore, any element in a claim that does not explicitly state “means for” performing a specified function, or “step for” performing a specific function, is not to be interpreted as a “means” or “step” clause as specified in 35 U.S.C. Section 112, Paragraph 6. In particular, the use of “step of” or “act of” in the claims herein is not intended to invoke the provisions of 35 U.S.C. 112, Paragraph 6.

Please note, if used, the labels left, right, front, back, top, bottom, forward, reverse, clockwise and counter clockwise have been used for convenience purposes only and are not intended to imply any particular fixed direction. Instead, they are used to reflect relative locations and/or directions between various portions of an object. Further, it should be noted that the terms first and second, etc. are used for numerical convenience purposes only to distinguish items and are not intended to be used as fixed numerical designators throughout the application.

(1) Description

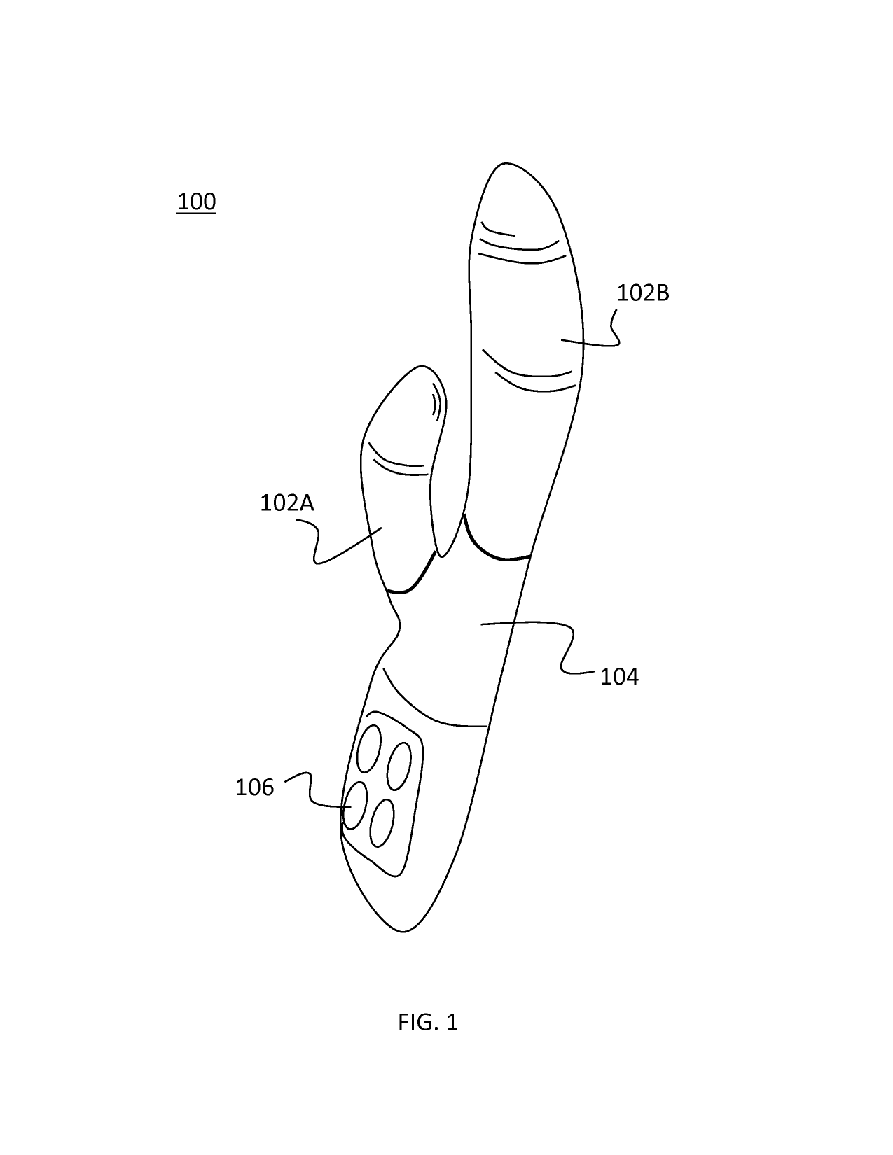

As shown in FIG. 1, the present invention is directed to a sexual stimulation device 100 with interchangeable sheaths 102A and 102B having different textures and pleasure patterns. The base component of the device 100 is a vibrating component 104. The vibrating component 104 includes the controls 106, power supply and vibration motors, etc. as may be necessary to provide vibration features and sensations. One or more interchangeable sheaths 102A and/or 102B can be selectively attached and detached from the vibrating component 104. Importantly and as an improvement over the prior art, the sexual stimulation device 100 can be sold as a kit with multiple interchangeable sheaths. The interchangeable sheaths can be provided with different textures and pleasure patterns to allow the user to selectively change the sheaths as desired.

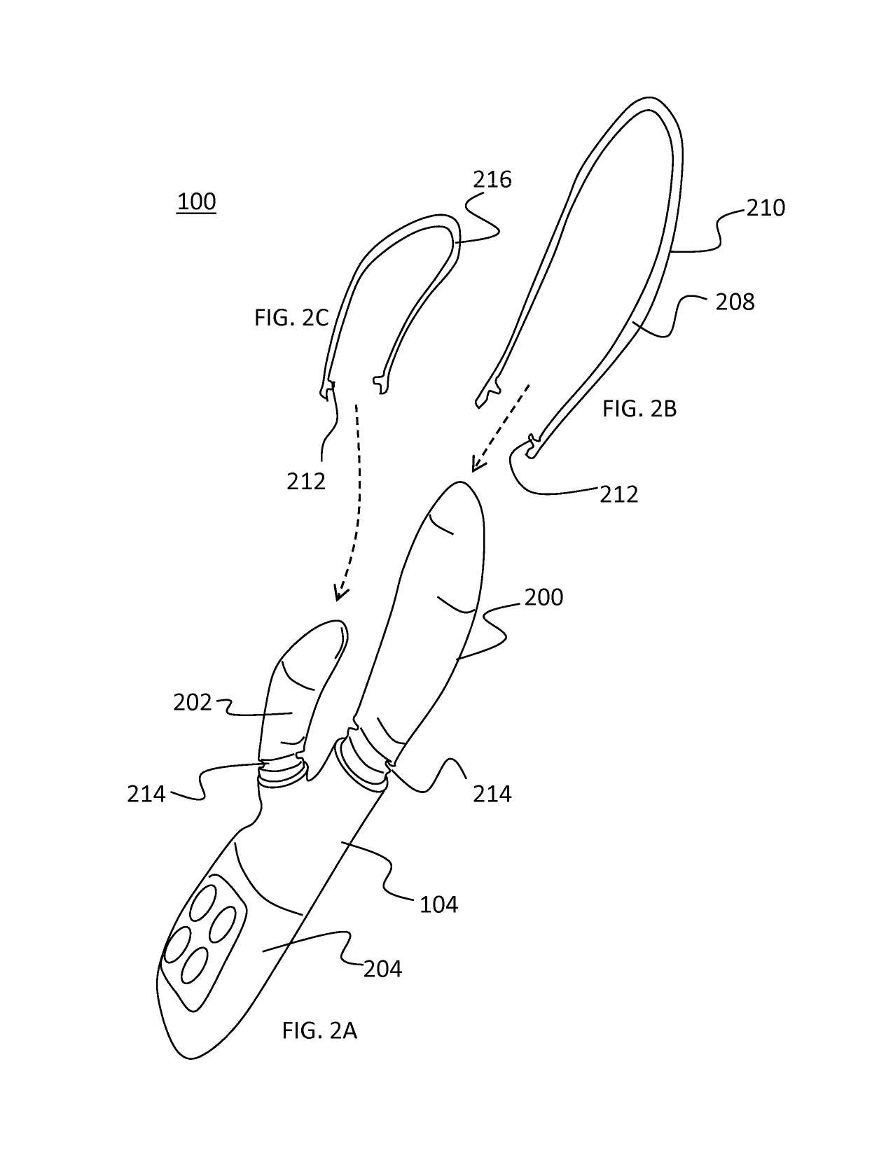

For further understanding, FIG. 2A is a side-view illustration a vibrating component 104 without interchangeable sheaths. The vibrating component 104 can be formed with a first vibrating member 200 (e.g., vaginal canal vibrator) and/or, optionally, with a second vibrating member 202 (e.g., clitoral vibrator). Thus, the vibrating component 104 includes a handle section 204 with one or more vibrating members (e.g., 200 and 202) extending therefrom. Importantly, at least one of the vibrating members is formed to allow a user to selectively attach and detach an interchangeable sheath with the vibrating component. For example, the first vibrating member 200 is formed to be selectively attached/detached from a first sheath. The sheaths are formed of any suitable material (e.g., latex, rubber, plastic, etc.) and in any suitable shape with any suitable texture and/or pattern. For example, FIG. 2B is a cross-sectional side-view illustration of a first interchangeable sheath 208 for attaching with the first vibrating member 200. In this example, the exterior 210 of the interchangeable sheath 208 is relatively smooth. However, it should be understood that the exterior 210 of the interchangeable sheath 208 can be formed in any desired texture, several examples of which are described below.

The interchangeable sheath 208 can be attached with the vibrating member 202 using any suitable connection technique, mechanism, marking, configuration, or device. In one aspect, the interchangeable sheath 208 can be formed of an elastic material (e.g., latex) such that it can be simply stretched around and affixed to the vibrating member 202 (similar in operation to a condom that is stretched around and affixed to a penis). In another aspect, the interchangeable sheath 208 can be formed with a sheath connection member 212 that is formed to connect with a corresponding base connection member 214. The connection members 212 and 214 are any suitable connection mechanism or configuration that allows for selectively attaching/detaching the two components. As a non-limiting example, the sheath connection member 212 is a protrusion ring that runs around the interior circumference of the interchangeable sheath 208. The base connection member 214 is an indentation or channel that is formed around the circumference of the vibrating member 200 and that receives the protrusion ring (i.e., sheath connection member 212). Thus, when the interchangeable sheath 208 is slid over the vibrating member 200, the sheath connection member 212 matingly engages with the base connection member 214 to affix the sheath 208 with the vibrating member 200. If the sheath 208 is elastic or otherwise pliable or resilient (e.g., formed of latex or rubber), the user can then simply pull the sheath connection 212 member from the base connection member 214 to detach the sheath 208.

Similarly and as depicted throughout FIGS. 2A and 2C, the second vibrating member 202 can also be formed with a base connection member 214 for connecting with a second interchangeable sheath 216 and its corresponding sheath connection member 212. It should be understood that although the sexual stimulation device 100 is depicted as having both a first and second vibrating member 200 and 202, the invention is not intended to be limited thereto as it can be formed with only a first vibrating member 200. Also, although the device 100 is depicted as allowing for interchangeable sheaths on both the first and second vibrating members 200 and 202, it should be understood that the device 100 can be formed so that only one of the vibrating members 200 or 202 allows for an interchangeable sheath. For example, the first vibrating member 200 (e.g., vaginal canal vibrator) can be formed to allow for an interchangeable sheath while the second vibrating member 202 (e.g., clitoral vibrator) includes a sheath or external material that is permanently affixed with the second vibrating member 202. Thus, in this example, only the first vibrating member 200 is formed to allow a user to attach/detach a sheath.

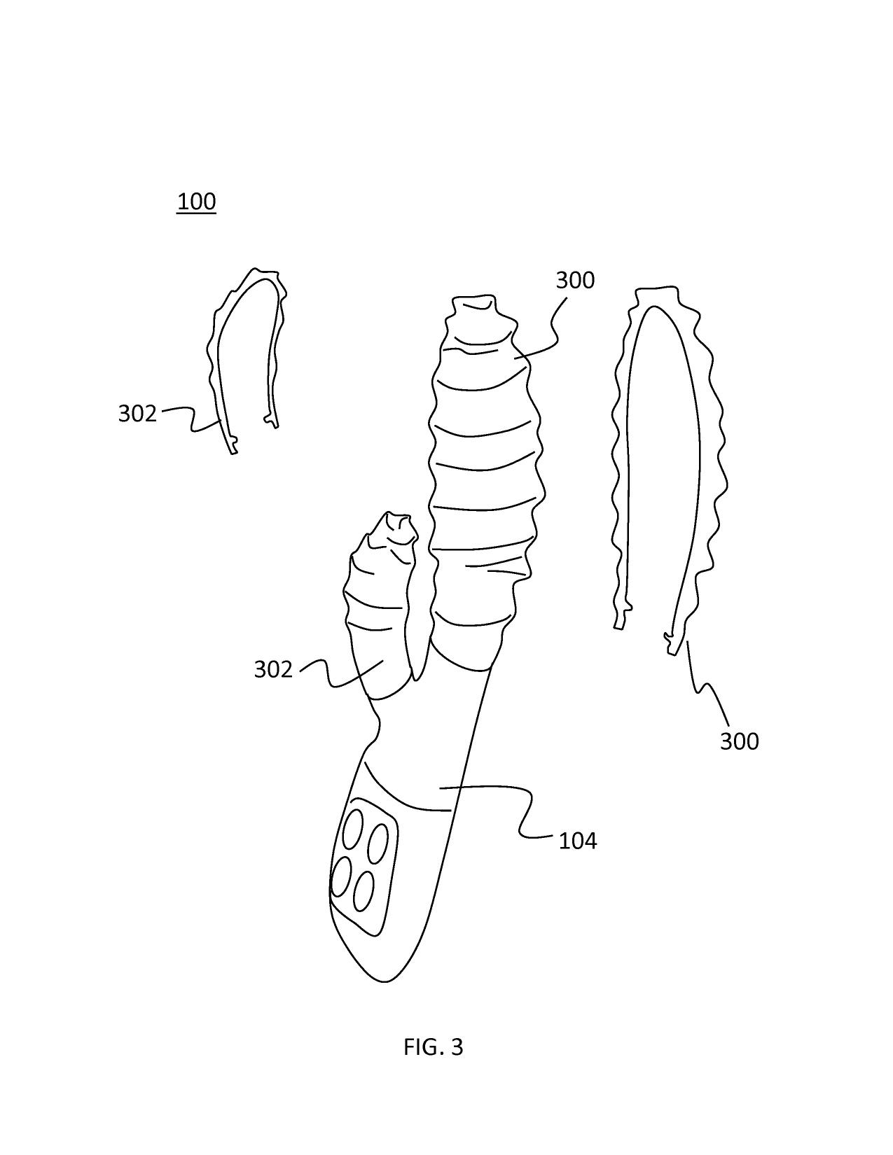

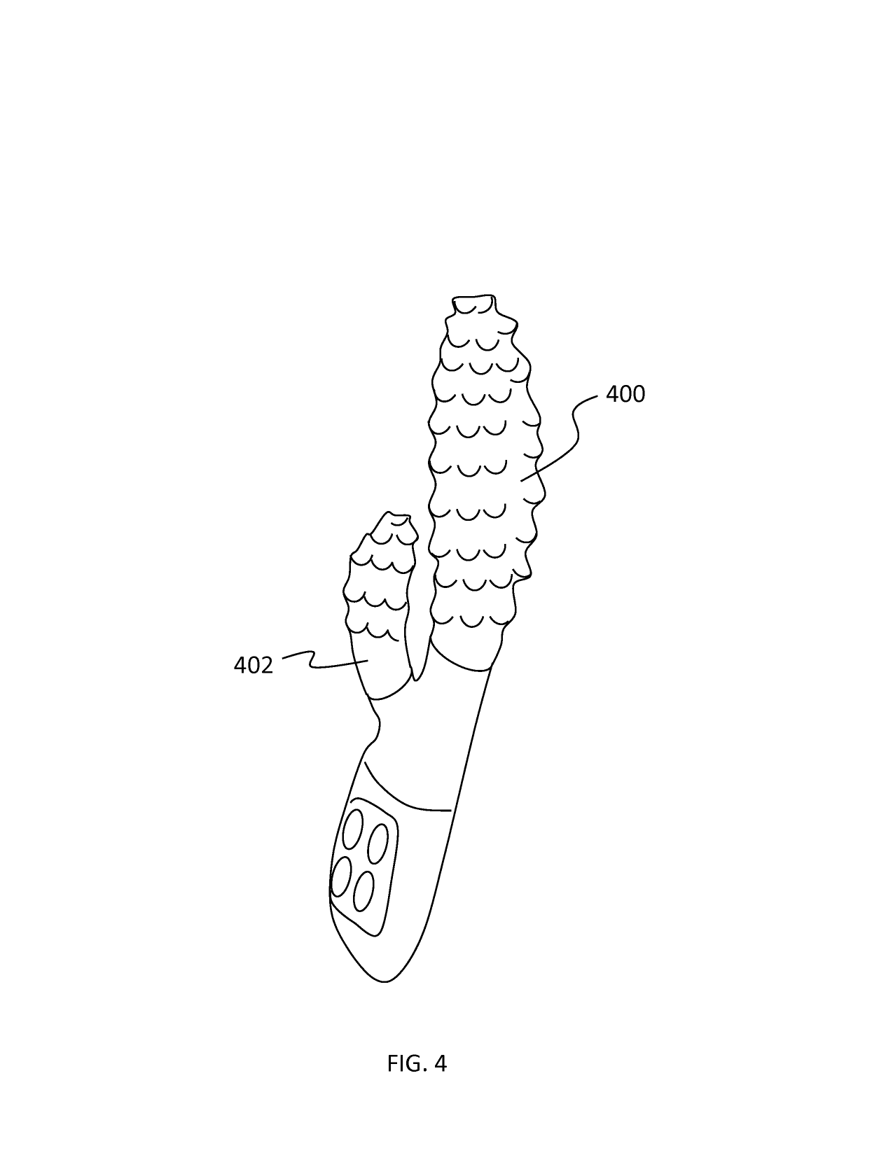

As noted above, an important feature of the present invention is that it allows a user to attach/detach a variety of interchangeable sheaths with varying textures and patterns. For example, FIG. 3 is a side-view illustration of the sexual stimulation device 100, depicting the vibrating component 104 with interchangeable sheaths 300 and 302 of alternative textures. For illustrative purposes, FIG. 3 depicts the interchangeable sheaths 300 and 302 in both cross-sectional views and as attached with the vibrating component 104. Additionally, FIG. 4 provides yet another example of interchangeable sheaths 400 and 402 with an alternative texture and/or pattern.

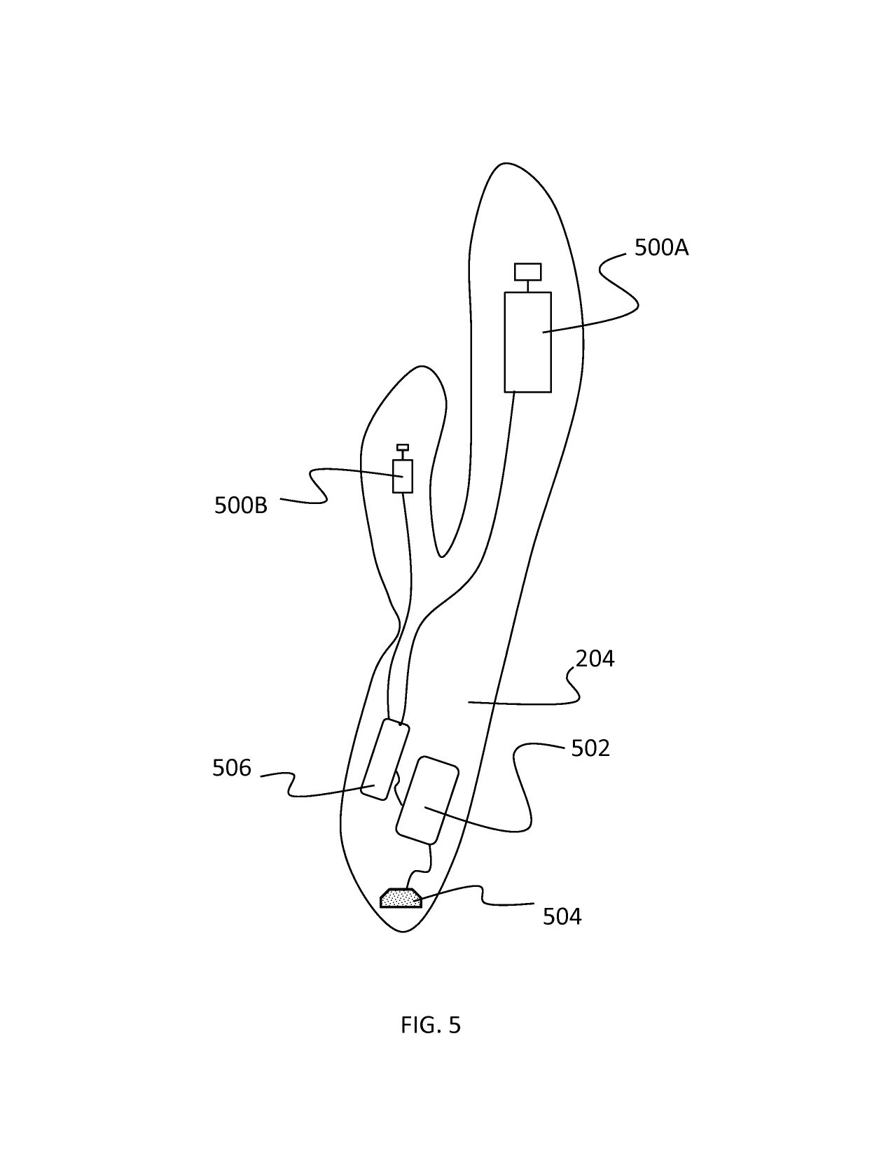

As can be appreciated by one skilled in the art and as depicted in FIG. 5, the sexual stimulation device 100 includes any desired components to provide for the desired vibration sensations. As a non-limiting example, a power supply is used to power one or more vibration motors 500A and 500B. If more than one vibration motor 500A and 500B is included, the device 100 can be formed to allow the user to operate them both in any suitable manner, a non-limiting example of which includes being operated simultaneously or independently. The power supply can be provided by a cord or by an internal power supply. As a non-limiting example, a battery 502 can be attached with or housed within the handle section 204. The battery 502 can be replaceable or rechargeable. As a non-limiting example, the battery 502 is a rechargeable battery that can be recharged through a micro-USB port 504 using computer or other charge capable device (e.g., charger). Although not absolutely necessary, an integrated circuit 506 is desirably included. The integrated circuit 506 can be operably connected with the controls (depicted as element 106 in FIG. 1) to allow a user to control the vibration functions of the vibration motors 500A and 500B. Additionally, the sexual stimulation device 100 can be sealed such that it is waterproof to protect the various internal components depicted in FIG. 5.

Finally, in another aspect, heating coils or other heating elements can be positioned with the sexual stimulation device 100 to provide thermal features to the device 100.

What is claimed is:

1. A sexual stimulation device, comprising:
a handle component;
a first vibrating member extending from the handle component, the first vibrating member being operable for providing a vibration sensation; and
a first interchangeable sheath with a first exterior texture, the first interchangeable sheath being adapted to detachably attach with the first vibrating member.

2. The sexual stimulation device as set forth in claim 1, further comprising a second interchangeable sheath with a second exterior texture, the second interchangeable sheath being adapted to detachably attach with the first vibrating member, and wherein the second exterior texture is distinct from the first exterior texture.

3. The sexual stimulation device as set forth in claim 2, further comprising a second vibrating member extending from the handle component, the second vibrating member being operable for providing a vibration sensation.

4. The sexual stimulation device as set forth in claim 3, further comprising a third interchangeable sheath with a third exterior texture, the third interchangeable sheath being adapted to detachably attach with the second vibrating member.

5. The sexual stimulation device as set forth in claim 4, further comprising a fourth interchangeable sheath with a fourth exterior texture, the fourth interchangeable sheath being adapted to detachably attach with the second vibrating member, and wherein the fourth exterior texture is distinct from the third exterior texture.

6. The sexual stimulation device as set forth in claim 5, wherein each vibrating member includes a base connection member and wherein each interchangeable sheath includes a sheath connection member that is formed to matingly engage with the corresponding base connection member.

7. The sexual stimulation device as set forth in claim 6, wherein each base connection member is a channel that is formed around a circumference of the vibrating member and each sheath connection member is a ring that runs around an interior circumference of the interchangeable sheath.

8. The sexual stimulation device as set forth in claim 1, wherein the vibrating member includes a base connection member and wherein the interchangeable sheath includes a sheath connection member that is formed to matingly engage with the base connection member.

9. The sexual stimulation device as set forth in claim 8, wherein the base connection member is a channel that is formed around a circumference of the vibrating member and the sheath connection member is a ring that runs around an interior circumference of the interchangeable sheath.
